(19) United States
(12) Patent Application Publication
(10) Pub. No.: US 2015/0375710 A1
(43) Pub. Date: Dec. 31, 2015

(54) AIRBAG FOR A VEHICLE OCCUPANT RESTRAINT SYSTEM AND METHOD FOR FOLDING AN AIRBAG FOR A VEHICLE OCCUPANT RESTRAINT SYSTEM

(71) Applicant: TAKATA AG, Aschaffenburg (DE)

(72) Inventors: Thomas SIEVERS, Ulm (DE); Christian BROSCH, Kettershausen (DE)

(73) Assignee: TAKATA AG, Aschaffenburg (DE)

(21) Appl. No.: 14/749,101

(22) Filed: Jun. 24, 2015

(30) Foreign Application Priority Data
Jun. 25, 2014 (DE) DE102014212238.4

(51) Int. Cl. B60R 21/237; B60R 21/231

(52) U.S. Cl. CPC B60R 21/237; B60R 21/23138; B60R 2021/23107

(57) ABSTRACT

An airbag for a vehicle occupant restraining system of a motor vehicle is provided. The airbag comprises a pre-folded portion, which comprises at least two subsections of the airbag, of which the one subsection is folded about a folding line via bend folding to an inner side of the other subsection facing the vehicle interior space in the mounted and inflated status of the airbag. The folded subsection is formed such that it extends in the mounted and inflated status of the airbag beyond a door balustrade of a vehicle longitudinal side. The airbag further comprises a roll folded portion, which comprises the pre-folded portion, wherein the roll folded portion is formed by rolling up the airbag to an outer side of the airbag facing in the mounted and inflated status of the airbag a vehicle longitudinal side.

### CROSS-REFERENCE TO RELATED APPLICATION

This application claims priority to German Patent Application No. 10 2014 212 238.4 filed on Jun. 25, 2014, the entirety of which is incorporated by reference herein.

### BACKGROUND

The invention relates to an airbag for a vehicle occupant restraint system and a method for folding an airbag for a vehicle occupant restraint system.

Head protection side airbags (HSAB—head side airbags) are known from the prior art, which extend in the inflated status along a vehicle longitudinal side. Such airbags are in particular dimensioned such that they extend in the inflated status at least with a section downwards (towards the vehicle floor) beyond a door balustrade of the vehicle longitudinal side. This serves to prevent a moving of the airbags during an accident out of a window of the vehicle since already a partial movement of the airbags would be accompanied with a substantial deterioration of its protective effect. An airbag extending beyond the door balustrade is described for instance in U.S. Pat. No. 7,775,553 B2.

It is furthermore known to fold at least a lower area of the head protection side airbag with a roll folding towards the vehicle longitudinal side (outboard). This has the effect that the airbags unroll from the vehicle longitudinal side when introducing gas such that they can unfold better between a vehicle occupant being close to the vehicle longitudinal side and the vehicle longitudinal side. Such airbags folded by outboard roll folding can unfold in particular between a head of the vehicle occupant being close to a side window or even laying against the side window (so called head-on-glass-case). Such an airbag is disclosed for instance in U.S. Pat. No. 6,851,707 B2. The outboard roll folding reinforces however the tendency of the airbags to move out of a broken side window in the course of an accident.

### SUMMARY

An object to be solved by the invention is to provide an airbag with better protective effect also for a vehicle occupant not being in a usual sitting position and over a longer period after activation of the airbag as well as to provide a corresponding method for folding an airbag.

This problem is solved by providing an airbag with the features as described herein and providing a method for folding an airbag with the features as described herein.

Accordingly an airbag for a vehicle occupant restraint system of a motor vehicle is provided with
a pre-folded portion, which comprises at least two subsections of the airbag of which one is folded about a folding line to a an inner side of the other sub-sections facing the motor vehicle interior space in a mounted and inflated status of the airbag,
wherein the folded subsection is formed such that it extends in the mounted and inflated status of the airbag beyond a door balustrade of a vehicle longitudinal side; and
a roll folded portion, which comprises the pre-folded portion, wherein
the roll folded portion is formed by rolling up the airbag to an outer side of the airbag facing a vehicle longitudinal side in the mounted and inflated status of the airbag, wherein
the folding line is positioned such that the pre-folded portion extends at least in a section of the airbag (i.e. in a cross section of the folded airbag oriented vertical to the main extension direction of the airbag) over the complete roller folded portion.

In other words, the airbag according to the invention comprises a portion which is formed by a combination of a bend folding towards the vehicle interior space (“inboard” folding) and the roll folding conducted towards a vehicle outer side (“outboard” roll folding). The roll folding provides in particular that the airbag can unfold also between a vehicle occupant being close to the vehicle longitudinal side and the vehicle longitudinal side. An unrolling of the airbag out of a window of the vehicle longitudinal side is however counteracted by the pre-folding (flapping) of the airbag present in the roll folded portion.

The height of the folded sub-section (i.e. its expansion transvers to the folding line) of the airbag is dimensioned such that the pre-folded portion of the airbag extends at least in a section of the airbag (for instance in a front and/or a back section) over the complete roll folded portion, i.e. at least in a section of the airbag the complete roll folded portion comprises at least two sub-sections of the airbag folded on top of each other. The folded sub-section forms in the mounted and inflated status of the airbag a lower portion of the airbag (facing the vehicle floor).

The bend folding of the airbag beforehand of the roll folding and the large height of the folded sub-section effect that after unrolling of the airbag or in a later stadium of the unrolling of the airbag the folded subsection is at least partially on an inner side of the airbag and thus moves coming from the vehicle interior space towards the door balustrade and/or a section of the vehicle side structure being underneath the door balustrade and in particular comes to a stop there.

Furthermore the folded sub-section (i.e. the lower portion of the airbag) is filled due to a throttle effect of the pre-folding (the bend of the pre-folded portion acts as a throttle) only late after an activation of the airbag, in particular only in the final phase of the unfolding of the roll folded portion. Thereby it can be avoided that the lower sub-section of the airbag is pushed in direction of the vehicle longitudinal side and possibly out of a side window due to a premature filling of the folded lower sub-section even before a complete unrolling of the airbag.

Accordingly, the airbag according to the invention counteracts a movement of the airbag and thus of the vehicle occupant to be protected out of the window of the vehicle longitudinal side (“ejection mitigation”—avoiding an ejection).

The combination of “inboard” pre-folded (“inboard” bend folding) and “outboard” roll folding means in particular that the folded sub-section of the pre-folded portion of the airbag is folded clockwise or counterclockwise about the folding line, looked at from a front to a back end of the folding line (wherein the “front end”—in respect to the mounted status of the airbag in the vehicle—is closer to the vehicle front than the “back end”), wherein the roll folded area is formed by rolling up the airbag—looked at from a front side of the airbag (i.e. a side of the airbag facing the vehicle front)—is formed counterclockwise, if the folded sub-section of the pre-folded portion is folded clockwise, and by rolling up the airbag clockwise, if the sub-section of the pre-folded area is folded counterclockwise.

In case of an airbag, which is to be arranged on a right vehicle longitudinal side (looked at from the vehicle front), the roll folding occurs by rolling up the lower, pre-folded portion of the airbag counterclockwise (looked at from a front side of the airbag or from the vehicle front), while the pre-folding beforehand of the roll folding is carried out clockwise about the folding line. In case of the airbag to be arranged on the left vehicle longitudinal side the roll folding occurs accordingly vice versa clockwise and the pre-folding counterclockwise.

According to an embodiment of the invention the pre-folded portion of the airbag does not end with the roll folded portion, but extends beyond the roll folded portion. In this variant the (folded) airbag comprises thus also a section outside of the roll folded portion, in which at least two sub-sections of the airbag are folded on top of each other.

It is also conceivable that a zick-zack folded portion is adjacent to the roll folded portion. For instance the pre-folded portion ends at the beginning of the zick-zack folded portion. The zick-zack folded portion comprises for instance multiple folding lines, wherein the pre-folded portion extends up to the folding line which is closest to the roll folded portion. It is however also possible that the pre-folded portion extends into the zick-zack folded portion.

In another variant of the invention the pre-folded portion of the airbag is formed by folding the airbag along multiple folding lines such that the pre-folded portion comprises at least three sub-sections of the airbag folded on top of each other.

The airbag is formed in particular by two airbag layers connected to each other along at least one circumferential seam such that the pre-folded portion comprises at least four sections of the airbag layers folded on top of each other.

It is also possible that the two airbag layers are connected to each other in a portion, which continues at least approximately along the folding line. For instance, the connection of the airbag layers occurs via a tear seam and/or a glue seam via which the sections of the inner side of the airbag layers are glued together.

The pre-folded portion of the airbag can extend at least essentially over the complete length of the airbag. The “length of the airbag” is the extension of the airbag in a main extension direction, i.e. for instance in respect to the mounted status in the vehicle and the inflated status of the airbag according to its length along the vehicle longitudinal direction.

For instance the folding line of the pre-folded portion and a roll axis of the roll folding continue at least approximately parallel to each other. In particular the folding line and the roll axis are oriented parallel to the main extension direction of the airbag, i.e. for instance along the vehicle longitudinal direction.

It is however also conceivable that the folding line and a roll axis of the roll folding are oriented to each other in an angle. The roll axis is for instance aligned parallel to the main extension direction of the airbag, while the folding line is oriented in an angle to the main extension direction. In this case the pre-folded portion extends in particular only over a part of the length of the airbag.

It is also possible that the airbag comprises two pre-folded portions (e.g. distanced from each other), which comprise in each case a subsection of the airbag folded about a folding line, wherein the folding lines of the pre-folded portions are oriented to each other for instance at an angle.

The airbag according to the invention is for instance a side airbag, which extends along a vehicle longitudinal side in the vehicle mounted and inflated status. It is in particular the previous mentioned head protection side airbag.

The invention relates also to a method for folding an airbag of a vehicle occupant restraint system for a motor vehicle with the steps:
providing an evenly spread airbag;
generating a pre-folded portion of the airbag by folding a subsection of the airbag about a folding line to an inner side of another subsection of the airbag facing the vehicle interior space in the mounted and inflated status of the airbag such that the folded portion comprises at least two subsections of the airbag,
wherein the folded subsection is formed such that it extends beyond a door balustrade of a vehicle longitudinal side in the mounted and inflated status of the airbag, and
generating a roll folded portion of the airbag which comprises the pre-folded portion, by rolling up the airbag to an outer side of the airbag facing a vehicle longitudinal side in the mounted and inflated status of the airbag, wherein
the folding line is positioned such that the pre-folded portion extends at least in a section of the airbag over the complete roll folded portion.

### BRIEF DESCRIPTION OF THE DRAWINGS

The invention is explained in the following by means of examples with reference to the figures in more detail.

FIGS. 1A-1D a side airbag in cross section for different steps of folding the airbag in a method according to an embodiment of the invention.

FIGS. 2A-2C different stages of unfolding of an airbag folded according to FIGS. 1A-1D and mounted in a vehicle.

FIG. 3 a perspective view of a side airbag in an intermediate status during folding according to the method of the invention.

FIG. 4 a side airbag in an intermediate status during folding after modifying the method according to the invention.

FIGS. 5A-5D Variants of the pre-folding of the method for folding an airbag according to the invention.

FIG. 6 a top view onto a side airbag according to an embodiment of the invention in unfolded status.

### DETAILED DESCRIPTION

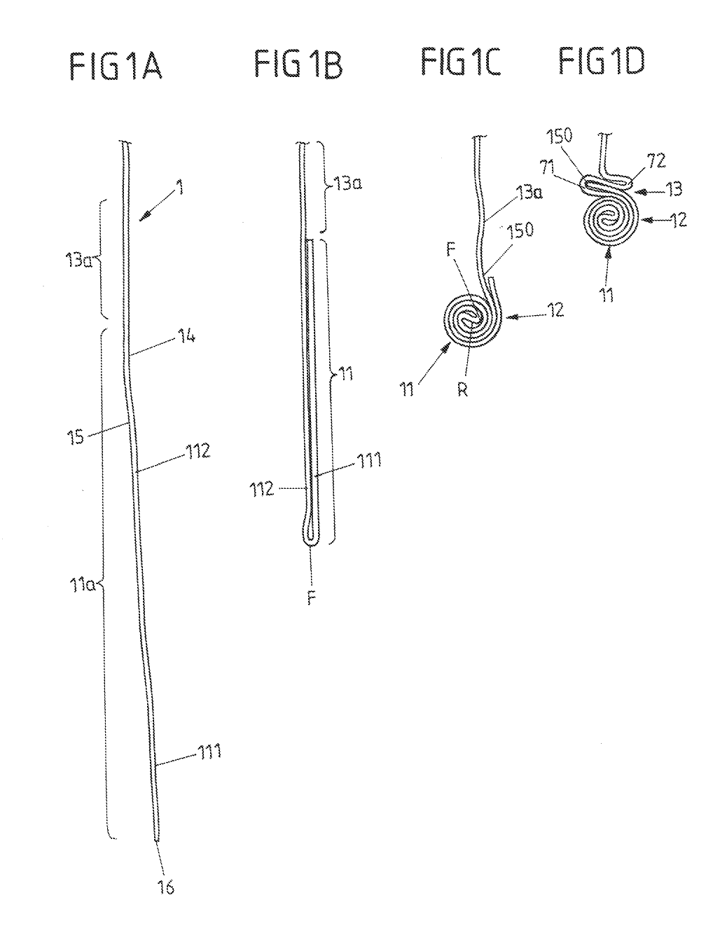

FIG. 1A shows a cut through an evenly spread airbag in form of a side airbag 1, which is going to be arranged in the vehicle such that it extends as a head protective airbag along a vehicle longitudinal side, i.e. it is a head side airbag (HSAB). The cut shown in FIG. 1 continues in a plane, which is oriented vertical to the main extension direction of the airbag, i.e. in respect to the mounted status in the vehicle along a plane, which continues parallel to a plane spanned through the vehicle cross and vehicle height direction (wherein the airbag is looked at from the vehicle front).

The side airbag 1 comprises a lower portion 11a, which—regarding the in the vehicle mounted and unfolded status of the airbag 1—faces the vehicle floor. The lower portion 11a is folded via bend folding and forms a pre-folded portion 11 (FIG. 1B). Above the portion 11a a portion 13a of the airbag 1 extends, which is folded via zick-zack folding in order to form a zick-zack folded portion 13, as illustrated in FIG. 1B. An inner side 14 of the side airbag 1 will extend in the unfolded status of the side airbag 1 facing the vehicle interior space while an outer side 15 facing away from the side 14 is oriented such that it will face a vehicle longitudinal side.

In order to generate the pre-folded portion 11 a lower sub-section 111 of the side airbag 1, which comprises a lower edge section 16 of the airbag 1, is folded along a folding line F until it extends parallel to a further sub-section 112 being above the sub-section 111 and joining the sub-section 111 and (looked at vertical to the extension plane of the side airbag 1) is arranged adjacent (and namely on an inner side of the sub-section 112 facing the vehicle interior space; compare FIG. 1B). It is conceivable that (although this is not imperative) the lower folded sub-section 111 rests against the upper sub-section 112.

The folding of the lower sub-section 111 occurs thus to an inner side of the upper sub-section 112, i.e. in respect to FIG. 1A counterclockwise about the folding line F (bend line). After folding the lower sub-section 111 the sub-sections 111, 112 form the pre-folded portion 11, i.e. the pre-folded portion 11 is the portion of the side airbag 1 in which the two sub-sections 111, 112 connected to each other via the folding line F, are arranged side by side. Accordingly the extension (heights vertical to folding line F) of the pre-folded portion 11 is determined by the extension of the folded lower subsection 111, i.e. by the position of the folding line F.

After generating the pre-folded portion 11 the side airbag 1 is provided with a roll folding. Thereby the side airbag 1 is rolled up from a lower edge, in which the folding line F continues, of the pre-folded portion 11 upwards (towards the portion 13a to be folded via zick-zack folding) and namely to the outer side 15 of the side airbag 1, i.e. in form of an outboard folding. By rolling up the side airbag 1 a roll folded portion 12 is formed, which is on an outer side of the non-rolled upper portion (approximately of the portion 13a) of the side airbag 1.

Due to the outboard roll folding a middle axis R and the lower edge of the pre-folded portion 11 is in particular located about the folding line F on an outer side of the non-rolled and not yet folded upper portion of the side airbag 1 (compare FIG. 1C), i.e. at the beginning of the outboard roll folding the lower edge of the pre-folded portion 11 is moved to an outer side (which faces a vehicle longitudinal side in the mounted status of the airbag) of the sub-section 112 and the not yet folded upper portion of the side airbag 1. The outboard roll folding has the advantage that the airbag can unfold easier also between a vehicle occupant (in particular its head) being close to a vehicle side structure (for instance a window plane) and the vehicle side structure.

The pre-folded portion 11 is dimensioned such (i.e. the folding line F is positioned such) that it extends over the complete roll folded portion 12 wherein an end 150 of the pre-folded portion 11 coincides with an end of the roll folded portion 12. In other words the complete roll folded portion 12 comprises the sub-sections 111, 112 of the pre-folded portion 11 arranged adjacent to each other.

After obtaining the roll folded portion 12 the upper section 13a of the side airbag 1 is folded via zick-zack folding wherein a zick-zack folded portion 13 is generated (FIG. 1D).

The zick-zack folded portion 13 follows the roll folded portion 12 and comprises a first and a second folding line Z1, Z2. The roll folded portion 12 extends up to the first folding line Z1 of the zick-zack folded portion 13, wherein the first folding line Z1 is closer to the roll folded portion 12 than the second folding line Z2. It is of course conceivable that the zick-zack folded portion 13 has more than two foldings (i.e. more than two folding lines) and/or that the pre-folded portion 11 extends beyond the first folding line Z1.

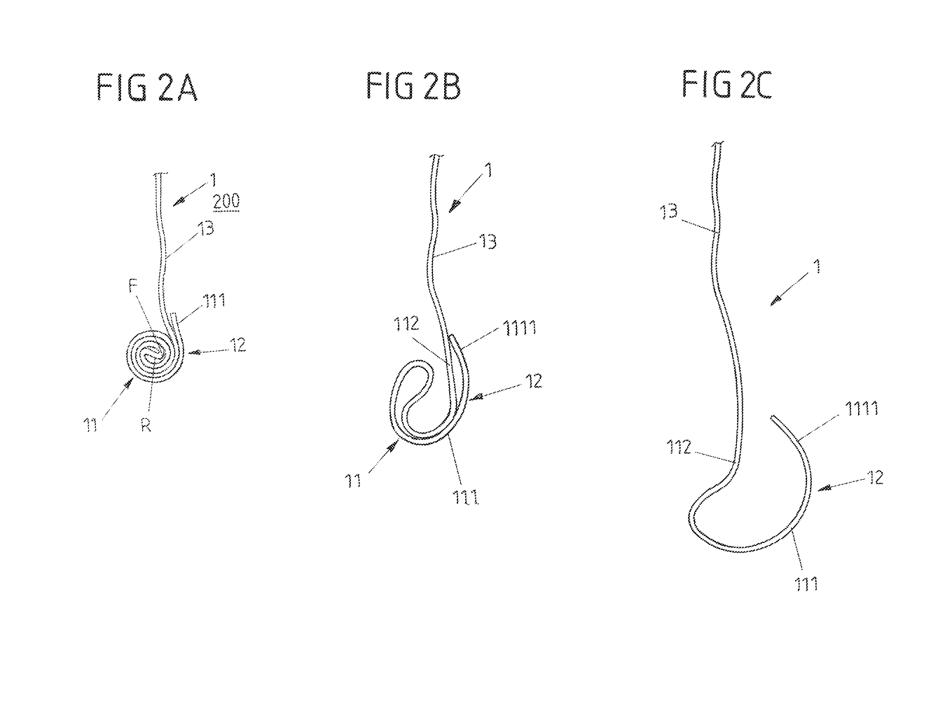

When activating the side airbag 1, i.e. after activating a gas generator provided for filling the side airbag 1 (not shown), at first the upper portion, in particular the zick-zack folded portion 13, of the side airbag 1 is filled with gas such that initially the portion 13 is essentially unfolded (FIG. 2A). Subsequently the roll folded portion 12 (FIG. 2B) unfolds (unrolls), namely with a unroll movement counterclockwise (in respect to FIG. 2A and the middle axis R moving downwards).

The (height) length of the lower sub-section 111 is moreover dimensioned such that after the unfolding of the zick-zack folded portion 13 an end 1111 of the lower folded sub-section 111 is on the inner side 14 of the zick-zack folded portion 13, i.e. on a side of the side airbag 1 facing a vehicle interior space 200. Since the folded sub-section 111 is bend from the upper sub-section 112 about the folding line F the folded sub-section 111 fills with a time delay (the bend along the folding line F acts as a throttle). This entails that the folded sub-section 111 is essentially non-filled during the unfolding of the roll folded portion 12 and remains thus pressureless whereby it experiences no force which would move it outwards (to the left side of the airbag 1 regarding FIG. 2B), i.e. in direction of the vehicle longitudinal side. Only when the roll folded portion 12 is predominantly or almost completely unrolled, the folded sub-section 111 is also filled. Since at least the end 1111 of the sub-section 111 is positioned however on an inner side of the airbag 1 (for instance the sub-section 112) the sub-section 111 will hit against an inner side of a door balustrade coming from the vehicle interior space and can thus not move outwards through a (for instance broken) side window of the vehicle (FIG. 2C).

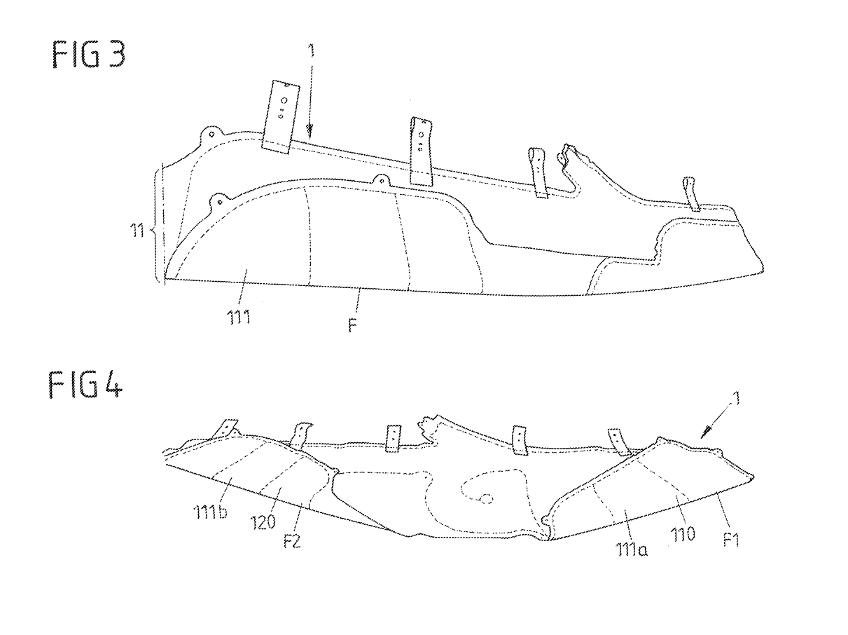

FIG. 3 shows a perspective view of a side airbag 1 after obtaining the pre-folded portion 11 by folding the lower sub-section 111 to an inner side of the side airbag 1 about the folding line F. In the example of FIG. 3 the folding line F continues along the main extension direction of the side airbag 1, wherein the folded sub-section 111 extends essentially over the complete length (along the main extension direction) of the side airbag 1.

In a next step the folded portion 11 would be folded per roll folding to an outer side of the side airbag 1 and optionally also per zick-zack folding (corresponding to FIGS. 1C and 1D). The roll folding is carried out along a roll axis moving upwards, which continues at least approximately parallel to the folding line F.

In the embodiment of FIG. 4 a front pre-folded portion 110 and a back pre-folded portion 120 is generated instead of one single pre-folded portion 11. The front pre-folded portion 110 is obtained by folding a front sub-section 111a of the side airbag 1 along a folding line F1 oriented inclined to a main extension direction of the side airbag 1. The back folded portion 120 is generated by folding a back sub-section 111b of the side airbag 1 about a folding line F2 continuing also in an angle to the main extension direction of the side airbag 1. The folding lines F1, F2 are oriented to each other also in an angle, wherein they continue towards each other looked at from an upper edge of the side airbag 1.

As in the previous embodiments a roll folding of the airbag 1 follows the generation of the pre-folded portions 110, 120. Said roll folding occurs in particular by rolling up the side airbag 1 from bottom to top (i.e. vertical to the main extension direction of the side airbag 1 or about a roll axis oriented parallel to the main extension direction of the side airbag 1). A middle section of the side airbag 1 between the pre-folded portions 110, 120 is not pre-folded in this embodiment. Accordingly, no pre-folded portion is located in said section of the side airbag 1, which extends into the roll-folded portion. However, the pre-folded portions 110, 120 are provided such that they extend in each case into the roll folded portion and at least partially over the complete roll folded portion.

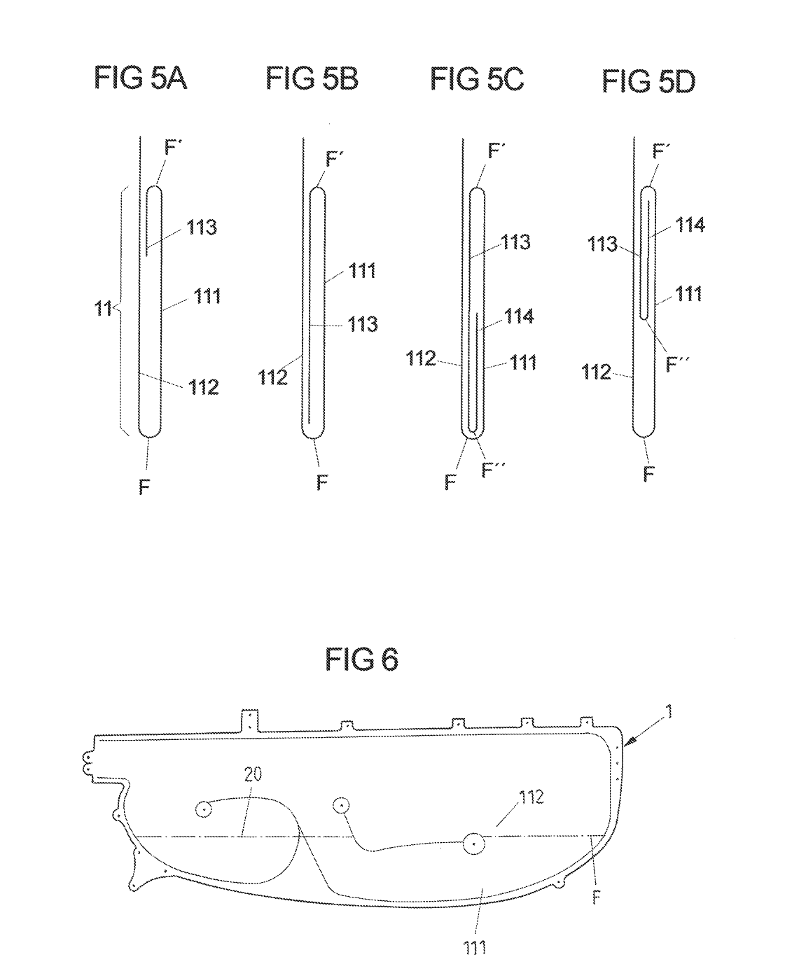

FIGS. 5A-5D show further variants of obtaining the pre-folded portion 11 of the side airbag. According to FIG. 5A the pre-folded portion 11 is generated by folding two sub-sections 111, 113 along two folding lines F, F′ to an inner side of the initial upper sub-section 112. Accordingly, the pre-folded portion 11 comprises three sub-sections 111-113 of the side airbag 1 adjoining each other (e.g. being on top of each other).

FIG. 5B resembles FIG. 5A, wherein however the third sub-section 113 is provided longer and comprises in particular at least approximately a length, which corresponds to the length of the first and second sub-sections 111, 112.

According to FIG. 5C the pre-folded section 11 is formed by carrying out a three times folding (along three folding lines F, F′, F″) such that four sub-sections 111-114 of the side airbag 1 being on top of each other are formed. It is similar also in FIG. 5D wherein however the length of the inner sub-sections 113, 114 (being between the sub-sections 111, 112) is smaller compared to FIG. 5C.

FIG. 6 relates to a further embodiment of the invention. Accordingly, the side airbag 1 is provided along the folding line F with a glue seam 20 (e.g. in form of a silica seam) which connects the inner sides of two airbag layers of the airbag 1 to each other. The glue seam 20 provides that the inflation of the lower sub-section 111 of the side airbag 1 folded about the folding line F is further delayed since the glue seam 20 has to be ripped open only by the pressure of the gas flowing into the airbag. This glue seam 20 could be provided with a through opening or with multiple through openings for adjusting the delay time. It is also conceivable that instead of a glue seam a tear seam is provided, which can be reinforced by a seam tape.

### LIST OF REFERENCES

1 Side airbag

11, 110, 120 Pre-folded portion

11 a Portion to be pre-folded

12 Roll folded portion

13 Zick-zack folded portion

13a Zick-zack portion to be folded

14 Inner side

15 Outer side

16 Lower edge

20 Glue seam

111, 111a, 111b Lower sub-section

112 Upper sub-section

113 Third sub-section

114 Forth sub-section

150 End of pre-folded portion

200 Vehicle interior space

1111 End of upper sub-section

F, F′, F″ Folding line

R Middle axis of roll folded portion

1. An airbag for a vehicle occupant restraint system of a motor vehicle comprising
a pre-folded portion which comprises at least two subsections of the airbag of which one of the subsections is folded about a folding line via bend folding to an inner side of the other subsections facing a motor vehicle interior space in a mounted and inflated status of the airbag,
wherein the folded subsection is formed such that it extends in a mounted and inflated status of the airbag beyond a door balustrade of a vehicle longitudinal side; and
a roll folded portion, which comprises the pre-folded portion, wherein
the roll folded portion is formed by rolling up the airbag to an outer side of the airbag facing a vehicle longitudinal side in the mounted and inflated status of the airbag,
wherein the folding line is positioned such the pre-folded portion extends at least in a section of the airbag over the complete roll folded portion.

2. The airbag according to claim 1, wherein the folded subsection is folded about the folding line, looked at from a front to a back end of the folding line, clockwise or counterclockwise, wherein the roll folded portion is formed by rolling the airbag counterclockwise, looked at from a front side of the airbag, if the folded subsection is folded clockwise, and by rolling the airbag clockwise, if the folded subsection is folded counterclockwise.

3. The airbag according to claim 1, wherein the pre-folded portion extends beyond the roll folded portion.

4. The airbag according to claim 1, wherein a zick-zack folded portion is adjacent to the roll folded portion.

5. The airbag according to claim 4, wherein the pre-folded portion extends up to the zick-zack folded portion or into the zick-zack folded portion.

6. The airbag according to claim 5, wherein the zick-zack folded portion comprises a plurality of folding lines, wherein the pre-folded portion extends at least up to the folding line which has the least distance to the rollfolded portion.

7. The airbag according to claim 1, wherein the pre-folded portion is formed by folding the airbag along multiple folding lines such that the pre-folded portion comprises at least three folded subsections adjoining each other.

8. The airbag according to claim 1, wherein the airbag is formed by two airbag layers connected to each other along at least one circumferential seam such that the pre-folded portion comprises at least four sections of airbag layers folded on top of each other.

9. The airbag according to claim 8, wherein the two airbag layers are connected to each other in a portion, which continues at least approximately along the folding line.

10. The airbag according to claim 9, wherein the two airbag layers are connected to each other via a tear seam and/or a glue seam.

11. The airbag according to claim 1, wherein the pre-folded portion extends at least essentially over the complete length of the airbag.

12. The airbag according to claim 1, wherein the folding line and a roll axis of the roll folding continue at least approximately parallel to each other.

13. The airbag according to claim 1, wherein the folding line and a roll axis of the roll folding are oriented to each other in an angle.

14. The airbag according to claim 1, wherein the airbag is a side airbag which extends along a vehicle longitudinal side in respect to the in the vehicle installed and inflated status.

15. A method for folding an airbag for a vehicle occupant restraint system for a motor vehicle comprising the steps:
Providing an evenly spread airbag;
Generating a pre-folded portion of the airbag by folding a subsection of the airbag about a folding line to an inner side of another subsection of the airbag facing the vehicle interior space in the mounted and inflated status of the airbag such that the pre-folded portion comprises at least two subsections of the airbag,
Wherein the folded subsection is formed such that it extends beyond a door balustrade of a vehicle longitudinal side in the mounted and inflated status of the airbag; and
Generating a roll folded portion of the airbag which comprises the pre-folded portion, by rolling up the airbag to an outer side of the airbag facing a vehicle longitudinal side in the mounted and inflated status of the airbag,
Wherein the folding line is positioned such that the pre-folded portion extends at least in a section of the airbag over the complete roll folded portion.
